(19) United States
(12) Patent Application Publication
(10) Pub. No.: US 2008/0064378 A1
(43) Pub. Date: Mar. 13, 2008

(54) MEDIA PLAYING ON ANOTHER DEVICE

(76) Inventors: Ariel Yehoshua Kahan, Jerusalem (IL); David Elliot Goldfarb, Bet Shemesh (IL); Andrew Goldman, Bet Shemesh (IL); Jonathan William Medved, Jerusalem (IL)

Correspondence Address: DANIEL J SWIRSKY, 55 REUVEN ST., BEIT SHEMESH, 99544, omitted

(21) Appl. No.: 11/853,117

(22) Filed: Sep. 11, 2007

Related U.S. Application Data
(60) Provisional application No. 60/843,423, filed on Sep. 11, 2006.
(60) Provisional application No. 60/829,903, filed on Oct. 18, 2006.

(51) Int. Cl. H04M 3/42; G06F 15/16; H04L 12/66

(52) U.S. Cl. 455/414.1; 370/352; 709/205

(57) ABSTRACT

A method includes initiating the playing of a user selected media clip on a buddy communication device through a community server. The method may include playing a buddy selected media clip on a user communication device. The community server brokers the media exchange. Another method includes receiving an SMS with a phone number of the buddy communication device after a conversation has concluded and then playing a buddy media clip.

### CROSS-REFERENCE TO RELATED APPLICATIONS

This application claims benefit from U.S. Provisional Patent Application No. 60/843,423, filed Sep. 11, 2006, and U.S. Provisional Patent Application No. 60/829,903, filed Oct. 18, 2006, both of which are hereby incorporated in their entirety by reference.

### FIELD OF THE INVENTION

The present invention relates to cellular telephones generally and to the playing of shared personalization content in particular.

### BACKGROUND OF THE INVENTION

A ringtone is a sound played on a phone handset, e.g. on a mobile cellular phone, to announce an incoming phone call. A ringtone is typically selected by the user of the phone receiving the call. A ringback tone is a sound played on a phone handset when calling another phone. Typically, the tone is chosen by the owner of the dialed phone.

A video ringtone or video ringback tone is similar, but uses a video clip rather than an audio sound.

FIG. 1, to which reference is now made, illustrates a media content sharing system 100 described in prior patent applications U.S. 60/771,883 and 60/772,564, assigned to the common assignees of the present invention and now incorporated into U.S. Ser. No. 11/544,938, also assigned to the common assignees of the present invention and incorporated herein by reference. When the content is video ringtones, the video ringtone chosen by the calling party is displayed on the called handset.

FIG. 1 shows a communication device 110, owned by, for example, Jack, and a telephone 120, owned by, for example, Jill, who are setting up or using a voice connection 140 for a telephone conversation. Jack and Jill are members of a content sharing community 150 and use a community server 130 for the selection and download of content, such as media clips, to be played on communication device 110. In the example, Jack and Jill are also “buddies”, members of community 150 who elect to share content with each other.

Community server 130 comprises a media clip selection database 132 which stores a collection of media clips 134 for selection by members of community 150. Jill accesses community server 130 via an Internet connection (arrow 131) and then selects a media clip 134 for her video ringtone.

A software client (not shown) on Jack's communication device 110 then downloads (arrow 133) Jill's media clip 134 to device 110. Communication device 110 comprises a media player 112, a personalization content manager 137, and buddy media clip database 138. Buddy media clip database 138 comprises media clips 136 which are copied, and possibly transcoded, versions of media clips 134 selected by Jack's buddies.

When Jill initiates a voice connection 140 from telephone 120 to Jack's communication device 110, personalization content manager 137 identifies her as one of Jack's buddies. Personalization content manager 137 then retrieves the media clip 136 originally selected by Jill and plays it as a video ringtone on media player 112, thus playing Jill's selected clip on Jack's phone when Jill calls.

Community 150 is also used in a similar manner to download other variations of video ringtones. For example, Jill can select a media clip 134 for a video ringback tone as well. After the selected media clip 134 is downloaded to Jack's device 110, it can be played as a video ringback tone when he calls Jill. Patent applications 60/771,883 and 60/772,564 also describe how community 150 can be used in a similar manner to select and distribute “ringbye” tones which are played at the end of a phone conversation.

Some communication devices 110 are incompatible with system 100 as described hereinabove. On J2ME handsets, for example, personalization content manager 137 typically cannot intercept an incoming phone call in order to launch the playing of media clip 136.

### SUMMARY OF THE PRESENT INVENTION

There is provided, in accordance with a preferred embodiment of the present invention, a method including initiating the playing of a user selected media clip on a buddy communication device through a community server.

Moreover, in accordance with a preferred embodiment of the present invention, the initiating includes sending a media exchange request to the buddy communication device via the community server. The request may include at least an indication of at least one of the user selected media clip and a user associated with the initiation.

Further, in accordance with a preferred embodiment of the present invention, the method includes receiving an acknowledgement of the playing of the user media clip on the buddy communication device. The acknowledgement may include at least an indication of when the playing is expected to complete.

Still further, in accordance with a preferred embodiment of the present invention, the method includes playing a buddy selected media clip.

Additionally, in accordance with a preferred embodiment of the present invention, the method includes enabling the initiation of a call between the user and a buddy associated with the buddy communication device.

Further, in accordance with a preferred embodiment of the present invention, the enabling occurs near the conclusion of the playing of the buddy selected media clip.

Still further, in accordance with a preferred embodiment of the present invention, the sending includes intercepting a dialing action and checking if a media exchange is desired.

Moreover, in accordance with a preferred embodiment of the present invention, the intercepting includes using a telephony API (application programming interface) to trap a call before the completion of the dialing action.

Additionally, in accordance with a preferred embodiment of the present invention, the enabling includes receiving timing information regarding the start time and expected duration for playing the user media clip, setting a timer in accordance with the timing information and initiating the call upon the expiration of the timer.

Further, in accordance with a preferred embodiment of the present invention, the setting includes adjusting the expected duration as a function of the time necessary to complete a call to the buddy communication device.

Still further, in accordance with a preferred embodiment of the present invention, the call uses at least one of the following: a voice connection for a standard voice call and a data connection for a voice over IP (internet protocol) call.

There is also provided, in accordance with a preferred embodiment of the present invention, a method including brokering a media exchange between a user communication device and a buddy communication device.

Additionally, in accordance with a preferred embodiment of the present invention, the media exchange is at least one of a media ringtone and a media ringback tone.

Further, in accordance with a preferred embodiment of the present invention, the brokering includes relaying timing information regarding the start time and expected duration for playing a user media clip on the buddy communication device to the user communication device.

Still further, in accordance with a preferred embodiment of the present invention, the brokering includes relaying timing information regarding the start time and expected duration for playing a buddy media clip on the user communication device to the buddy communication device.

Additionally, in accordance with a preferred embodiment of the present invention, the brokering uses one of the following: internet protocol and SMS (short message service).

There is also provided, in accordance with a preferred embodiment of the present invention, a method including on a buddy communication device, enabling an initiator communication device to initiate through a community server the playing of an initiator selected media clip on the buddy communication device.

Moreover, in accordance with a preferred embodiment of the present invention, the media clip is either a media ringtone or a media ringback tone.

Further, in accordance with a preferred embodiment of the present invention, the method also includes sending a media exchange acknowledgement to the initiator communication device. The media exchange acknowledgement includes timing information regarding the start time and expected duration for playing the initiator selected media clip.

Still further, in accordance with a preferred embodiment of the present invention, the method also includes receiving timing information regarding the start time and expected duration for playing a buddy media clip on the initiator communication device.

Moreover, in accordance with a preferred embodiment of the present invention, the method also includes setting a timer in accordance with the timing information and displaying a notice that a pending call is expected from an initiator after the timer expires.

Further, in accordance with a preferred embodiment of the present invention, the method also includes notifying that a media exchange request has been received from the initiator.

Still further, in accordance with a preferred embodiment of the present invention, the notifying includes at least one of the following: an audio alert and a message display.

Additionally, in accordance with a preferred embodiment of the present invention, the method also includes prompting for acceptance of the media exchange request.

There is also provided, in accordance with a preferred embodiment of the present invention, a method including enabling a conversation between at least two communication devices and upon conclusion of the conversation, sending an SMS with a phone number of one of the devices to at least another of the two devices.

There is further provided, in accordance with a preferred embodiment of the present invention, a method including on a user communication device, conducting a conversation with a buddy communication device, receiving an SMS with a phone number of the buddy communication device after the conversation has concluded and playing a buddy media clip associated with the phone number.

There is still further provided, in accordance with a preferred embodiment of the present invention, a communications device including a requester and a media player. The requester initiates the playing of a user selected media clip on at least one buddy communication device via a community server. The media player plays a media clip selected by the at least one buddy, if desired.

Moreover, in accordance with a preferred embodiment of the present invention, the requester includes a transmitter to send a media exchange request to the buddy communication device via the community server.

Further, in accordance with a preferred embodiment of the present invention, the requester also includes a unit to receive an acknowledgement of the playing of the user media clip on the buddy communication device.

Still further, in accordance with a preferred embodiment of the present invention, the device also includes a unit to initiate a call between the user and a buddy associated with the buddy communication device.

Moreover, in accordance with a preferred embodiment of the present invention, the unit includes an activation unit to initiate the call near the conclusion of the playing of the buddy selected media clip.

Additionally, in accordance with a preferred embodiment of the present invention, the transmitter includes an intercepter to intercept a dialing action and a checker to check if a media exchange is desired.

Further, in accordance with a preferred embodiment of the present invention, the intercepter includes a telephony API to trap a call before the completion of the dialing action.

Still further, in accordance with a preferred embodiment of the present invention, the unit to initiate includes a timer unit to set timers in accordance with timing information received from the community server and a call unit to initiate the call between the user and the buddy upon the expiration of at least one of the timers.

Moreover, in accordance with a preferred embodiment of the present invention, the timer unit also includes an adjuster to adjust the expected duration as a function of the time necessary to complete a call to the buddy communication device.

There is also provided, in accordance with a preferred embodiment of the present invention, a community server including a media exchange broker to broker a media exchange between a user communication device and a buddy communication device and a housing to house the media exchange broker.

Further, in accordance with a preferred embodiment of the present invention, the media exchange is at least one of a media ringtone and a media ringback tone.

Still further, in accordance with a preferred embodiment of the present invention, the broker includes a relayer to relay timing information regarding the start time and expected duration for playing a user media clip on the buddy communication device to the user communication device.

Moreover, in accordance with a preferred embodiment of the present invention, the broker includes a relayer to relay timing information regarding the start time and expected duration for playing a buddy media clip on the user communication device to the buddy communication device.

Additionally, in accordance with a preferred embodiment of the present invention, the broker uses one of the following: internet protocol and SMS.

There is also provided, in accordance with a preferred embodiment of the present invention, a communications device including a media player and a personalization content manager to provide an initiator selected media clip to the media player upon receipt of a request from an initiator communication device via a community server.

Moreover, in accordance with a preferred embodiment of the present invention, the personalization content manager includes an acknowledgement unit to send a media exchange acknowledgement to the initiator communication device.

Further, in accordance with a preferred embodiment of the present invention, the personalization content manager includes a timing unit to receive timing information regarding the start time and expected duration for playing a buddy media clip on the initiator communication device.

Still further, in accordance with a preferred embodiment of the present invention, the timing unit includes a timer unit to set a timer in accordance with the timing information and a displayer to display a notice that a pending call is expected from an initiator after the timer expires.

Additionally, in accordance with a preferred embodiment of the present invention, the device also includes a notifier to notify that a media exchange request has been received from the initiator.

Further, in accordance with a preferred embodiment of the present invention, the notifier includes a generator to generate at least one of the following: an audio alert and a message display.

Still further, in accordance with a preferred embodiment of the present invention, the notifier includes a prompter to prompt for acceptance of the media exchange request.

There is also provided, in accordance with a preferred embodiment of the present invention, a device including a unit to enable a conversation between at least two communication devices and an SMS transmitter to send an SMS, upon conclusion of the conversation, with a phone number of one of the devices to at least another of the two devices.

Finally, there is provided, in accordance with a preferred embodiment of the present invention, a communication device including a unit to receive an SMS with a phone number of a buddy communication device after a conversation with the buddy communication device has concluded and a media player to play a buddy media clip associated with the phone number.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a media content sharing system for the selection and distribution of media content, such as video ringtones;

FIG. 2 is a schematic illustration of a novel system for media-exchange-preceded calls, constructed and operative in accordance with a preferred embodiment of the present invention;

FIG. 3 is a flow chart illustrating the flow of control between the various entities included in the system of FIG. 2; and.

FIG. 4 is a schematic illustration of a novel operator-hosted SMS wakeup system for ringbyes, constructed and operative in accordance with a preferred embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

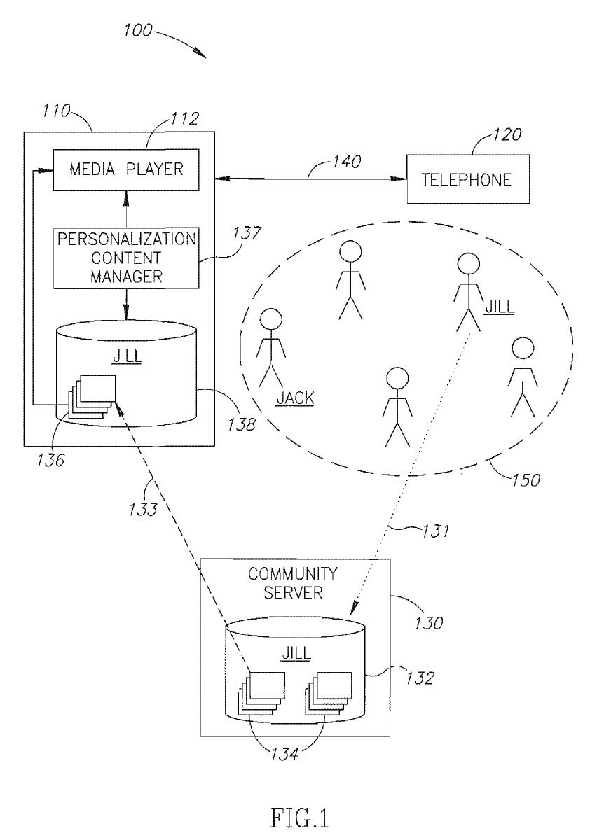

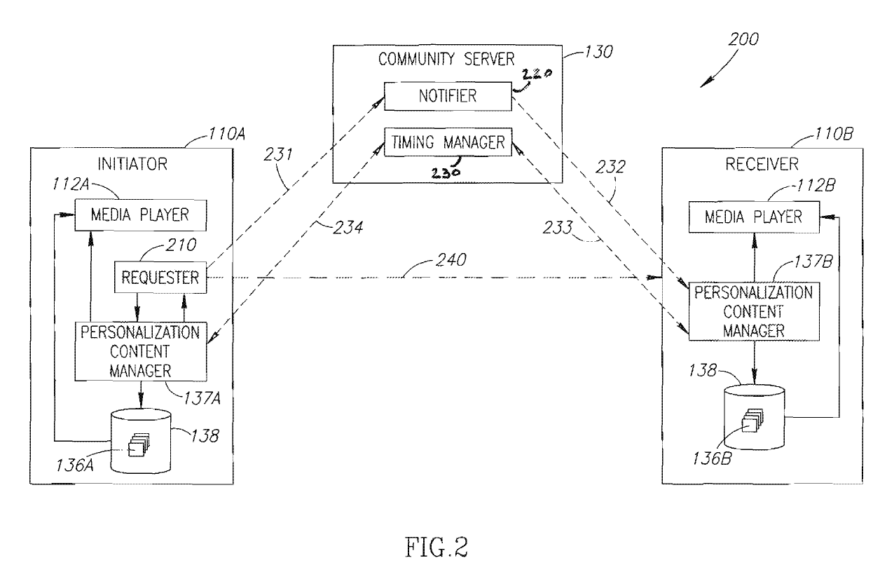

The present invention may be a novel system and method enabling members of community 150 (FIG. 1) to exchange media content with each other prior to, or instead of, initiating a call with each other. FIG. 2, to which reference is now made, illustrates a media-exchange-preceded calling system 100, constructed and operative in accordance with a preferred embodiment of the present invention.

System 200 may comprise a community server 130 and at least two communications devices 110 used by members of community 150 (FIG. 1). Communications devices 110 may communicate with community server 130 via connections 231, 232, 233 and 234. Communications devices 110 may also communicate with each other via a voice connection 240.

As in the system disclosed by U.S. patent application Ser. No. 11/544,938, system 200 may facilitate the sharing of media content to be used on the occasion of call-related activity between members of community 150 (FIG. 1). However, in accordance with a preferred embodiment of the present invention, system 200 may also be configured to broker media exchanges between its users, and thereby enable its users to perform media-exchange-preceded calls (herein referred to as “MEP calls”) between each other.

Communications device 110A may be used by an “initiator”, a user that wishes to initiate an MEP call to a second user. The second user is the “receiver” who receives the MEP call on device 110B. The initiator and receiver may be buddies that have elected to share media content with each other.

As in U.S. Ser. No. 11/544,938, communications devices 110 may comprise a media player 112, a personalization content manager 137 and a buddy media clip database 138 which may store one or more media clips 136 selected by the initiator's buddies. Communications device 110A may also comprise a requester 210 configured to perform MEP calls. It will be appreciated that the presentation of communications device 110B without a requester 210 is exemplary; device 110B may also comprise a requester 210.

Both the initiator and the receiver may have already selected a media clip 136 to be played on the other's device 110 on the occasion of call-related activity. Furthermore, the selected media clips 136 may have already been downloaded to each of the buddies' devices 110.

The initiator may use requester 210 to initiate an MEP call to the receiver's device 110B. It will be appreciated that communications device 110A may not be capable of directly contacting communications device 100B without immediately opening voice connection 240. In accordance with a preferred embodiment of the present invention, requester 210 may, instead, use community server 130 to relay an MEP call request to device 110B. Accordingly, requester 210 may use connection 231 to send a call request for device 110B to community server 130.

It will be appreciated that the MEP call request may include a representation of the identity of the initiator or of the possibly previously selected media clip 136.

Community server 130 may comprise a notifier 220 and a timing manager 230. Notifier 220 may receive the call request from requester 210 and may relay it via connection 232 to personalization content manager 137B on device 110B. It will be appreciated that connection 232 may be an Internet connection using standard Internet protocols such as HTTP, TCP or UDP to “push” the call request to device 110B. In accordance with an alternative embodiment of the present invention, an SMS message may also be sent to “wake up” personalization content manager 137B. For example, if device 110B is a J2ME handset, this may be accomplished using the “push registry” mechanism described by JSR 120.

Using the information in the call request, personalization content manager 137B may locate media clip 136B previously selected by the initiator, and may play it on media player 112B. It will be appreciated that the initiator may not wish to interrupt the receiver while media clip 136 may be playing. However, device 110A may require some information in order to estimate the approximate time that media clip 136B may finish playing. Accordingly, personalization content manager 137B may also use connection 233 to send details to timing manager 230 regarding the time media player 112B began to play clip 136B and/or the expected playing time. It will be appreciated that connections 232 and 233 may be different logical connections even though they may share a physical connection. Similarly, connections 231 and 234 may also share a physical connection.

Timing manager 230 may send these details via connection 234 to personalization content manager 137A on the originator's device 110A. Personalization content manager 137A may locate media clip 136A, previously selected by the receiver, and may play it on media player 112A. Personalization content manager 137A may also use connection 234 to send details to timing manager 230 regarding the time media player 112A began to play clip 136A on device 110A and/or the expected playing time.

Thusly, timing manager 230 may pass timing details back and forth between devices 110A and 110B over connections 233 and 234 in order to attempt to synchronize the playing and expected ending times for media clips 136A and 136B. Both personalization content managers 137 may set timers to expire in accordance with the expected playing time of media clip 136 on the other device 110.

In accordance with an alternative preferred embodiment of the present invention, these expiration timers may also be adjusted to compensate for expected delays in call completion between devices 110A and 110B. For example, the timer on device 110A may be adjusted to expire slightly before device 110B finishes playing media clip 136B. This adjustment may be generally equivalent to the time required to complete a call between devices 110A and 110B. Accordingly device 110A may “time” a call to arrive at device 110B as close as possible to the end of the play of media 136.

When the timer on device 110A expires, personalization content manager 137 may instruct requester 210 to establish a call with device 110B. Typically, this may be accomplished using the built-in dialer application programming interface (API) on communications device 110A.

It will be appreciated that device 110A may initiate playing of a media clip on device 110B immediately before initiating a telephone call. Thus, the present invention may be used as a novel means to push “ringtone”—like media clips to communication devices that do not support the interception of incoming calls.

It will be appreciated that the implementation of requester 210 may depend on the technical specifications of device 110A. For example, if device 110 supports such functionality, requester 210 may comprise a handler that may use standard APIs to trap outgoing calls initiated by the device's built-in dialer function. Alternatively, requester 210 may be a separate GUI application that may not have any call handling capabilities. Requester 210 may also be implemented as a separate GUI application that may handle both MEP calls and regular outgoing calls. The existing built-in dialer may also be customized, on devices that support such customization, to handle both types of calls.

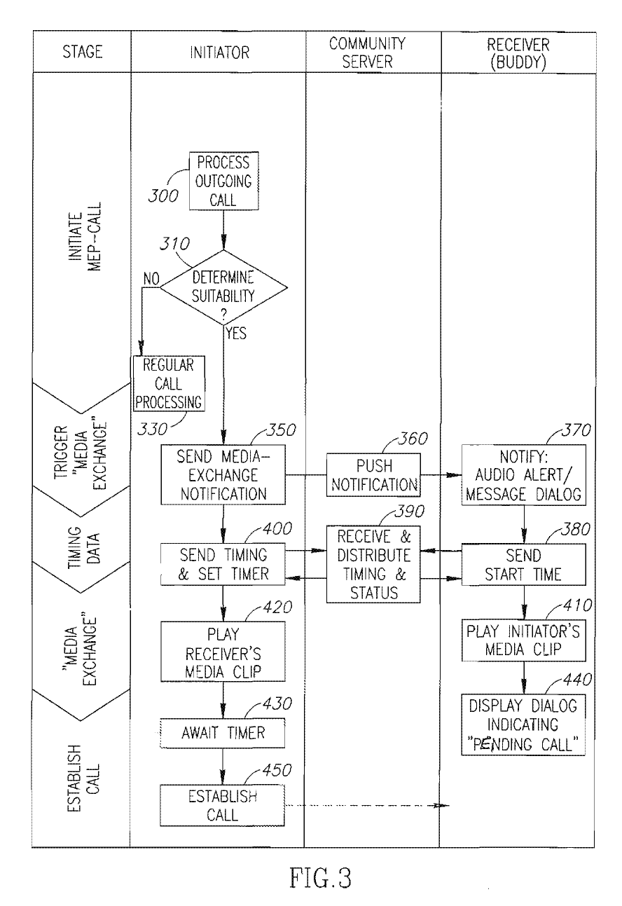

FIG. 3, to which reference is also now made, illustrates the flow of control between the various entities of system 200. The first column lists the various processing stages, and the other three columns illustrate the processing performed by the initiator's device 110A, community server 130, and the receiver's device 110B, respectively.

The initiator may begin by accessing requester 210 to initiate an MEP call to receiver's device 110B. In accordance with a preferred embodiment of the present invention, requester 210 may use APIs from the built-in dialing functionality of device 110A to trap outgoing calls. Accordingly, the initiator may request a media exchange with the receiver's device 110B by dialing the receiver's number or selecting the receiver from a contact list. In accordance with an alternative preferred embodiment of the present invention, requester 210 may comprise a dedicated GUI application which may be used to initiate an MEP call to a buddy.

In either case, requester 210 may process (step 300) the outgoing call, and may determine (step 310) whether or not the call is suitable for a media exchange. For example, requester 210 may check that device 110B belongs to a buddy. Some buddies may also be filtered out and depending on the circumstances may only receive regular calls.

Calls that are determined to be unsuitable for media exchanges may continue (step 350) with regular call processing. Otherwise, personalization content manager 137A may send (step 350) a media exchange notification to community server 130. Such notification may include the phone number dialed, a representation of the identity of the initiator or of the possibly previously selected media clip 136 and a request to set up an MEP call.

Notifier 220 on community server 130 may push (step 360) the MEP call request to device 110B. As discussed hereinabove, there are a number of alternatives for pushing this notification to device 110B. For example, the notification may be pushed via Internet protocols, or included in an SMS that may “wake up” personalization content manager 137B in order to process the incoming MEP call.

It will be appreciated that either of these may, in another embodiment, be provided directly from device 110A, rather than going through community server 130.

Personalization content manager 137B may notify (step 370) the receiver regarding the incoming MEP call via an audio alert and/or a message dialog. In accordance with a preferred embodiment of the present invention, the receiver may accept or refuse the incoming MEP call.

Personalization content manager 137B may send (step 380) the start time back to community server 130. It may also instruct media player 112B to play (410) media clip 136. It will be appreciated that sending the start time to community server 130 may constitute acknowledgement that the receiver is willing and able to accept the MEP call.

Timing manager 230 on community server 130 may receive (step 390) the start time from device 110B and may forward it to device 110A. Personalization content manager 137A on device 110A may send (step 400) timing information back to community server 130, and may set a timer to expire in accordance with the timing details received from device 110B via community server 130. It may also instruct media player 112A to play (420) media clip 136A.

Timing manager 230 may receive (step 390) the start time from device 110A and may forward it to device 110B.

Media clip 136B may continue to play on device 110B. Once media clip 136B finishes playing, personalization content manager 137B may display (step 440) a dialog indicating that a “pending call” may be expected from the initiator. In parallel, media clip 136A may continue playing on device 110A. Once media clip 136A finishes playing, personalization content manager 137A may wait (step 430) for the expiration of the timer set in step 400 before instructing requester 210 to establish (step 450) a call to the receiver's device 110B. Processing may then continue as with a regular call (step 330).

There may be other alternatives for establishing the voice call. For example, the receiver's device 110B may also be configured with a requester 210 to call the initiator's device 110A. Calls may also be established on appropriate devices/networks using other methods, such as via SIP (Session Initiation Protocol), for establishing a VoIP (Voice over IP) call.

Also, in accordance with an alternative preferred embodiment of the present invention, the initiator and/or receiver may elect not to establish a voice call after the media exchange.

There may also be a method for initiating a media exchange without using community server 130. In accordance with an alternative embodiment of the present invention, requester 210 may call receiver's device 110B and may immediately hang up. Personalization content managers 137 on both devices 110 may then instruct media players 112 to play media clips 136. As per the previous embodiment, a voice call may, or may not, be established between devices 110A and 110B after playing their respective media clips 136.

It will be appreciated that there may be times when the receiver is incapable or unwilling to receive an MEP call. System 200 may also comprise a login feature to track available devices 110. Notifier 220 may not push (step 360) a notification to a device 110 that is not already logged in. Furthermore, timing manager 230 may also set a timer while waiting for device 110B to send (step 380) a start time. An exemplary timer length may be 10 seconds. If a response is not received before the timer expires, it may be assumed that the receiver is either unavailable or unwilling to receive the MEP call.

In accordance with another preferred embodiment of the present invention, the receiver or initiator may record new media clips and/or may select existing media clips while media clips 136 are playing (steps 410 and 420) on their devices 110. These media clips may be sent to each other instead of, before, concurrent with, or after establishing (step 450) a voice call.

In accordance with another preferred embodiment of the present invention, personalization content managers 137 may enable the initiator and/or receiver to replay media clip(s) 136 instead of, before, concurrent with, or after establishing (step 450) a voice call. In such cases, any required timing information may be relayed between devices 110 by timing manager 230 in order to ensure that the initiator may not establish (step 450) a call while the receiver may be watching a replay of media clip 136B, and/or to inform the receiver that the initiator may still be watching clip 136B and may establish a call afterwards.

Prior patent application U.S. Ser. No. 11/775,249, assigned to the common assignees of the present invention and incorporated herein by reference, discloses a method by which media content sharing system 100 may be used to distribute media clip advertisements to devices 110. Such advertisements are then typically played on devices 110 as video ringtones, ringbacks and/or ringbyes on the occasion of call-related activity between members of community 150.

Applicants have realized that the “wake up” SMS described hereinabove may also be used to facilitate the playing of ringbyes in general, and ringbye advertisements in particular. Some communications devices may not be capable of passing call handling information to other applications on the device. Accordingly, the application may not be aware when the call has ended. The application also may not be capable of determining with whom the phone conversation took place.

However, in accordance with another preferred embodiment of the present invention, the communication device may work in conjunction with a back-end system that may be hosted by the mobile operator. When each phone call to/from the device ends, the operator's system may send the device a suitable “application wakeup” SMS message.

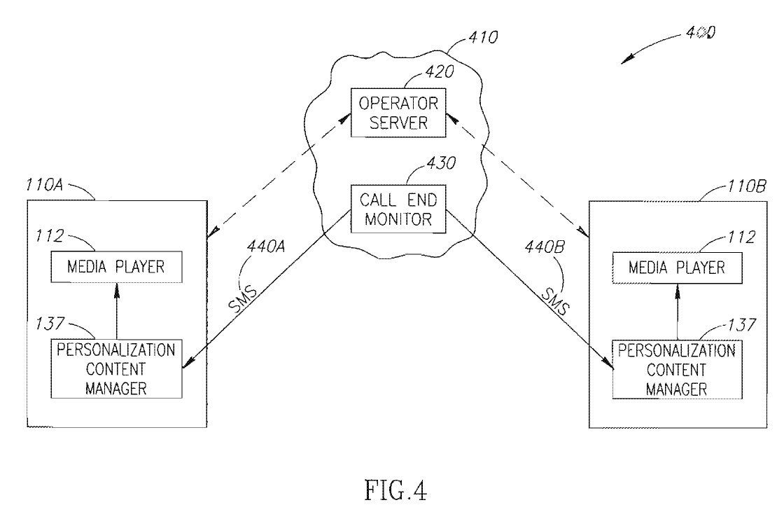

FIG. 4, to which reference is now made, illustrates an operator-hosted ringbye SMS wakeup system 400, constructed and operative in accordance with a preferred embodiment of the present invention. Communication devices 110A and 110B may complete calls with each other via a mobile network 410.

Mobile network 410 may comprise an operator server 420 and a call end monitor 430. Operator server may provide connection services between users of mobile network 410, for example, devices 110A and 110B. When a call between devices 110 ends, operator server 420 may alert call end monitor 430 and provide it with the phone numbers of both devices 110. Call end monitor 430 may then use the phone numbers to send an SMS to one or both device 110.

Each SMS message may include in its body an identification of the other phone number. For example, the SMS sent to device 110A may include the phone number of device 110B. Similarly, the SMS sent to device 110B may include the phone number of device 110A. The SMS may wake up a resident application on the device, for example, personalization content manager 137. Personalization content manager 137 may process the received information and may decide which (if any) media clip 136 to play.

It will be appreciated that the configuration of system 400 may be exemplary. Call end monitor 430, for example, may also be integrated within operator server 420. It will further be appreciated that call end monitor 430 and/or operator server 420 may also comprise logic to identify subscribers to the service provided by system 400.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
initiating the playing of a user selected media clip on a buddy communication device through a community server.

2. The method according to claim 1 and wherein said initiating comprises:
sending a media exchange request to said buddy communication device via said community server, said request including at least an indication of at least one of said user selected media clip and a user associated with said initiation.

3. The method according to claim 2 and also comprising:
receiving an acknowledgement of the playing of said user media clip on said buddy communication device, said acknowledgement including at least an indication of when said playing is expected to complete.

4. The method according to claim 2 and also comprising:
playing a buddy selected media clip.

5. The method according to claim 3 and also comprising enabling the initiation of a call between said user and a buddy associated with said buddy communication device.

6. The method according to claim 5 and also comprising playing a buddy selected clip wherein said enabling occurs near the conclusion of said playing of said buddy selected media clip.

7. The method according to claim 2 and wherein said sending comprises:
intercepting a dialing action; and
checking if a media exchange is desired.

8. The method according to claim 7 wherein said intercepting comprises using a telephony API (application programming interface) to trap a call before the completion of said dialing action.

9. The method according to claim 6 and wherein said enabling comprises:
receiving timing information regarding the start time and expected duration for playing said user media clip;
setting a timer in accordance with said timing information; and
initiating said call upon the expiration of said timer.

10. The method according to claim 9 and wherein said setting comprises adjusting said expected duration as a function of the time necessary to complete a call to said buddy communication device.

11. The method according to claim 5 and wherein said call uses at least one of the following: a voice connection for a standard voice call and a data connection for a voice over IP (internet protocol) call.

12. A method comprising:
brokering a media exchange between a user communication device and a buddy communication device.

13. The method according to claim 12 and wherein said media exchange is at least one of a media ringtone and a media ringback tone.

14. The method according to claim 13 and wherein said brokering comprises:
relaying timing information regarding the start time and expected duration for playing a user media clip on said buddy communication device to said user communication device.

15. The method according to claim 13 and wherein said brokering comprises:
relaying timing information regarding the start time and expected duration for playing a buddy media clip on said user communication device to said buddy communication device.

16. The method according to claim 13 and wherein said brokering uses one of the following:
internet protocol and SMS (short message service).

17. A method comprising:
on a buddy communication device, enabling an initiator communication device to initiate through a community server the playing of an initiator selected media clip on said buddy communication device.

18. The method according to claim 17 and wherein said media clip is at least one of a media ringtone and a media ringback tone.

19. The method according to claim 17 and also comprising sending a media exchange acknowledgement to said initiator communication device.

20. The method according to claim 19 and wherein said media exchange acknowledgement comprises timing information regarding the start time and expected duration for playing said initiator selected media clip.

21. The method according to claim 17 and also comprising receiving timing information regarding the start time and expected duration for playing a buddy media clip on said initiator communication device.

22. The method according to claim 21 and also comprising:
setting a timer in accordance with said timing information; and
displaying a notice that a pending call is expected from an initiator after said timer expires.

23. The method according to claim 17 and also comprising notifying that a media exchange request has been received from said initiator.

24. The method according to claim 23 and wherein said notifying comprises at least one of the following: an audio alert and message display.

25. The method according to claim 23 and also comprising prompting for acceptance of said media exchange request.

26. A method comprising:
enabling a conversation between at least two communication devices; and
upon conclusion of said conversation, sending an SMS with a phone number of one of said devices to at least another of said two devices.

27. A method comprising:
on a user communication device, conducting a conversation with a buddy communication device;
receiving an SMS with a phone number of said buddy communication device after said conversation has concluded; and
playing a buddy media clip associated with said phone number.

28. A communications device comprising:
a requester to initiate the playing of a user selected media clip on at least one buddy communication device via a community server; and
a media player to play a media clip selected by said at least one buddy if desired.

29. The device according to claim 28 and wherein said requester comprises:
a transmitter to send a media exchange request to said buddy communication device via said community server, said request including at least an indication of at least one of said user selected media clip and a user associated with said initiation.

30. The device according to claim 29 and wherein said requester also comprises:
means to receive an acknowledgement of the playing of said user media clip on said buddy communication device, said acknowledgement including at least an indication of when said playing is expected to complete.

31. The device according to claim 30 and also comprising means to initiate a call between said user and a buddy associated with said buddy communication device.

32. The device according to claim 31 and wherein said means comprises activation means to initiate said call near the conclusion of said playing of said buddy selected media clip.

33. The device according to claim 29 and wherein said transmitter comprises:
an intercepter to intercept a dialing action; and
a checker to check if a media exchange is desired.

34. The device according to claim 33 wherein said intercepter comprises a telephony API (application programming interface) to trap a call before the completion of said dialing action.

35. The device according to claim 32 and wherein said means to initiate comprises:
timer means to set timers in accordance with timing information received from said community server; and
call means to initiate said call between said user and said buddy upon the expiration of at least one of said timers.

36. The device according to claim 35 and wherein said timer means comprises an adjuster to adjust said expected duration as a function of the time necessary to complete a call to said buddy communication device.

37. The device according to claim 31 and wherein said call uses at least one of the following:
a voice connection for a standard voice call and a data connection for a voice over IP (internet protocol) call.

38. A community server comprising:
a media exchange broker to broker a media exchange between a user communication device and a buddy communication device; and
a housing to house said media exchange broker.

39. The server according to claim 38 and wherein said media exchange is at least one of a media ringtone and a media ringback tone.

40. The server according to claim 39 and wherein said broker comprises:
a relayer to relay timing information regarding the start time and expected duration for playing a user media clip on said buddy communication device to said user communication device.

41. The server according to claim 39 and wherein said broker comprises:
a relayer to relay timing information regarding the start time and expected duration for playing a buddy media clip on said user communication device to said buddy communication device.

42. The server according to claim 39 and wherein said broker uses one of the following:
internet protocol and SMS (short message service).

43. A communications device comprising:
a media player; and
a personalization content manager to provide an initiator selected media clip to said media player upon receipt of a request from an initiator communication device via a community server.

44. The device according to claim 43 and wherein said media clip is at least one of a media ringtone and a media ringback tone.

45. The device according to claim 43 and wherein said personalization content manager comprises acknowledgement means to send a media exchange acknowledgement to said initiator communication device.

46. The device according to claim 45 and wherein said media exchange acknowledgement comprises timing information regarding the start time and expected duration for playing said initiator selected media clip.

47. The device according to claim 43 and wherein said personalization content manager comprises a timing unit to receive timing information regarding the start time and expected duration for playing a buddy media clip on said initiator communication device.

48. The device according to claim 47 and wherein said timing unit comprises:
a timer unit to set a timer in accordance with said timing information; and
a displayer to display a notice that a pending call is expected from an initiator after said timer expires.

49. The device according to claim 43 and also comprising a notifier to notify that a media exchange request has been received from said initiator.

50. The device according to claim 49 and wherein said notifier comprises a generator to generate at least one of the following: an audio alert and a message display.

51. The device according to claim 49 and wherein said notifier comprises a prompter to prompt for acceptance of said media exchange request.

52. A device comprising:
means to enable a conversation between at least two communication devices; and
an SMS transmitter to send an SMS, upon conclusion of said conversation, with a phone number of one of said devices to at least another of said two devices.

53. A communication device comprising:
means to receive an SMS with a phone number of a buddy communication device after a conversation with said buddy communication device has concluded; and
a media player to play a buddy media clip associated with said phone number.
